(19) United States
(12) Patent Application Publication
(10) Pub. No.: US 2021/0025700 A1
(43) Pub. Date: Jan. 28, 2021

(54) MOUNTING APPARATUS FOR A WHEEL ALIGNMENT SYSTEM

(71) Applicant: Wyatt Anthony Kram, Fargo, ND (US)

(72) Inventor: Wyatt Anthony Kram, Fargo, ND (US)

(21) Appl. No.: 16/521,356

(22) Filed: Jul. 24, 2019

(51) Int. Cl. G01B 11/275

(52) U.S. Cl. CPC G01B 11/275; B62D 17/00

(57) ABSTRACT

Methods and apparatus are provided for attaching a wheel alignment instrument of a wheel alignment system to at least one stud of a wheel of a vehicle, including a plurality of mounting tools, each having a first body and a second body that move relative to each other so that the second body grippingly engages the wheel stud. A bracket attached to each of the mounting tools extends between the mounting tools.

### TECHNICAL FIELD

The present disclosure relates generally to vehicles and, more particularly, to devices that assist in performing wheel alignment operations.

### BACKGROUND

Wheel alignment systems used with large vehicles, such as semi tractors and trailers and larger vehicles, generally include respective optical devices attached to an opposing pair of wheels that it is desired to align. The optical device may include one or more cameras that feed image data to a central processor, or reflectors that reflect laser or other light from a remote camera module. The optical device is attached to the wheel by a bracket that attaches to wheel studs. The bracket has a rotatable tool for each stud. The tool has a threaded end to receive the end of the threaded stud, and the tool is then rotated to thread down onto the stud. Typically, at least two to three inches of the stud must be available, with the result that lug nuts must often be removed to facilitate the tools' attachment to the studs.

### SUMMARY

In an embodiment of the present disclosure, a mounting apparatus for attaching a wheel alignment instrument of a wheel alignment system to at least one stud of a wheel of a vehicle has a plurality of mounting tools. Each mounting tool of the plurality of mounting tools has a first body and a second body disposed with respect to the first body so that a relative movement between the first body and the second body causes an engagement between the first body and the second body that drives the first body into gripping engagement with a wheel stud received by the second body. A bracket attached to each mounting tool of the plurality of mounting tools extends between the mounting tools of the plurality of mounting tools at a predetermined position with respect to the wheel when the mounting tools are mounted on the wheel and has a mount configured to receive the wheel alignment instrument so that the wheel alignment instrument is disposed at a predetermined orientation with respect to the wheel.

In another embodiment, a mounting apparatus for attaching a wheel alignment instrument of a wheel alignment system to at least one stud of a wheel of a vehicle has a first mounting tool and a second mounting tool. Each of the first mounting tool and the second mounting tool has an elongated body having a front end, a rear end and a through bore extending along a longitudinal center axis of the elongated body, and a collet defining an internal bore configured to receive a wheel stud therein. The collet is slidably received in the through bore of the elongated body so that an outer surface of the collet abuts an inner surface of the front end of the elongated body. the collet is axially slidable with respect to the elongated body between a first position in which the collet is rotatable with respect to the wheel stud and a second position in which the inner surface of the front end of the elongated body engages the outer surface of the collet to drive the collet to grippingly engage the wheel stud. A bracket has a first end that is secured to the first mounting tool, a second end that is secured to the second mounting tool, and a mounting stud configured for selectively disposing the wheel alignment instrument on the bracket.

In yet another embodiment, a wheel alignment system for a wheel of a vehicle, the wheel having a plurality of studs has a first mounting tool and a second mounting tool. Each of the first mounting tool and the second mounting tool has an outer body, which has an elongated outer body portion having a front end, a rear end and a through bore extending along a longitudinal center axis of the outer body portion, an inner body, which has an elongated inner body portion having a front end and a rear end, and a collet secured to the front end of the inner body portion. The collet defines an internal bore configured to receive a wheel stud therein. The inner body portion is slidably received in the through bore of the outer body portion so that an outer surface of the collet abuts an inner surface of the front end of the outer body portion. The inner body is axially slidable with respect to the outer body between a first position in which the collet is rotatable with respect to the wheel stud and a second position in which the inner surface of the front end of the outer body portion engages the outer surface of the collet to drive the collet to grippingly engage the wheel stud. A bracket defines a first mounting aperture, a second mounting aperture, and a mounting stud extending outwardly therefrom. The first mounting tool extends through the first mounting aperture, and the second mounting tool extends through the second mounting aperture. A wheel alignment instrument is selectively disposed on the mounting stud of the bracket.

In a still further embodiment, a mounting apparatus for attaching a wheel alignment instrument of a wheel alignment system to a wheel has a plurality of mounting tools. Each mounting tool has a collar that defines a first internal bore and a first engagement surface, and a collet disposed slidably within the first internal bore. The collet has a plurality of jaws that define an exterior second engagement surface and a second internal bore. The collet is slidable within the first internal bore between a first position with respect to the collar in which the first engagement surface and the second engagement surface are disposed with respect to each other so that a diameter of the second internal bore is greater than an outer surface diameter of a wheel stud of the wheel and a second position with respect to the collar in which the first engagement surface and the second engagement surface engage each other and force the jaws radially inward so that the jaws grippingly engage the wheel stud when the wheel stud is disposed within the second internal bore. A bracket is attached to each mounting tool of the plurality of mounting tools. The mounting bracket extends between the mounting tools of the plurality of mounting tools at a predetermined position with respect to the wheel when the mounting tools of the plurality of mounting tools are mounted on the wheel and has a mount thereon configured to receive the wheel alignment instrument so that the wheel alignment instrument is disposed at a predetermined orientation with respect to the wheel.

In another embodiment, a method of attaching a wheel alignment instrument of a wheel alignment system to at least one stud of a wheel of a vehicle includes providing a plurality of mounting tools. Each mounting tool of the plurality of mounting tools has a first body and a second body. The second body is disposed with respect to the first body so that a relative movement between the first body and the second body causes an engagement between the first body and the second body that drives the first body into gripping engagement with a wheel stud received by the second body. A bracket is provided that is attached to each mounting tool of the plurality of mounting tools. The bracket extends between the mounting tools of the plurality of mounting tools at a predetermined position with respect to the wheel when the mounting tools of the plurality of mounting tools are mounted on the wheel and has a mount configured to receive the wheel alignment instrument so that the wheel alignment instrument is disposed at a predetermined orientation with respect to the wheel. The wheel alignment instrument is mounted on the mount.

The accompanying drawings, which are incorporated in and constitute a part of this specification, illustrate one or more embodiments of the disclosure and, together with the description, serve to explain the principles thereof.

### BRIEF DESCRIPTION OF THE DRAWINGS

The disclosure now will be described more fully hereinafter with reference to the accompanying drawings, in which some, but not, all embodiments are shown. Indeed, the subject matter of this disclosure may be embodied in many different forms and should not be construed as limited to the embodiments set forth herein.

FIG. 1 is a plan view of a mounting apparatus for a wheel alignment system, in accordance with an embodiment of the present disclosure;

FIG. 2 is a perspective view of a mounting tool of the mounting apparatus shown in FIG. 1;

FIG. 3 is a side view of the mounting tool shown in FIG. 2;

FIG. 4 is a front view of the mounting tool shown in FIG. 2;

FIG. 5 is a rear view of the mounting tool shown in FIG. 2;

FIG. 6 is an exploded side view of the mounting tool shown in FIG. 2;

FIG. 7 is a cross-sectional view of the mounting tool shown in FIG. 2, taken along line 7-7 of FIG. 5;

FIGS. 8A and 8B are perspective and side views, respectively, of the outer body of the mounting tool shown in FIG. 2;

FIGS. 9A and 9B are perspective and side views, respectively, of the front end cap of the mounting tool shown in FIG. 2;

FIGS. 10A and 10B are perspective and side views, respectively, of the tapered ring of the mounting tool shown in FIG. 2;

FIGS. 11A and 11B are perspective and side views, respectively, of the collet mounting tool shown in FIG. 2;

FIGS. 12A and 12B are perspective and side views, respectively, of the rear end cap of the mounting tool shown in FIG. 2;

FIGS. 13A and 13B are perspective and side views, respectively, of the inner body of the mounting tool shown in FIG. 2;

FIG. 14 is a side view of the inner body portion of the mounting tool shown in FIG. 2;

FIGS. 15A and 15B are perspective and side views of the rear plug of the mounting tool shown in FIG. 2;

FIGS. 16A and 16B are perspective and plan views, respectively, of the mounting bar of the mounting apparatus shown in FIG. 1;

FIGS. 17A, 17B, and 17C are perspective, side, and front views, respectively, of the stud adaptor for use with the mounting apparatus shown in FIG. 1, in accordance with an embodiment of the present invention;

FIG. 18 is a side view of the body portion of the stud adaptor shown in FIGS. 17A through 17C;

FIG. 19 is a side view of the front end cap of the stud adaptor shown in FIGS. 17A through 17C;

FIG. 20 is a perspective view of the mounting apparatus shown in FIG. 1 secured to the wheel of a vehicle;

FIG. 21 is a perspective view of a wheel alignment instrument supported on the mounting apparatus as shown in FIG. 18; and

FIG. 22 is a perspective view of the stud adaptor shown in FIGS. 17A through 17C secured to the wheel of a vehicle.

Repeat use of reference characters in the present specification and drawings is intended to represent same or analogous features or elements of the disclosure.

### DETAILED DESCRIPTION

The disclosure now will be described more fully hereinafter with reference to the accompanying drawings, in which some, but not, all embodiments thereof are shown. Indeed, this invention may be embodied in many different forms and should not be construed as limited to the embodiments set forth herein.

It should be understood that terms of orientation, e.g. “forward” and “rearward,” as used herein are intended to refer to relative orientation of components of the devices described herein with respect to each other under an assumption of a consistent point of reference but do not require any specific orientation of the overall system. Thus, for example, the discussion herein may refer to a “forward” or “front” end of a mounting tool, referring to a direction toward the end of the tool that receives a wheel stud, or a “rearward” end of the mounting tool, referring to a direction toward the mounting tool's connection to the bracket. The present discussion may also refer to “upper” and/or “lower” surfaces of components, with regard to the mounting tools' orientation as reflected by FIG. 7. Those directional references, however, apply regardless whether or how the bracket and mounting tools may actually be oriented with respect to a vehicle wheel.

In addition, when components are described herein as being “non-rotatably” disposed with respect to, attached or fixed to, or otherwise related to each other, it should be understood that such components are disposed, attached, fixed, or otherwise related to each other so that the components do not rotate with respect to each other during operation of the system as described herein but that the components may be rotatable with respect to other components or devices. Such components, though non-rotatable in operation, may in some instances be rotatable with each other in disassembly, e.g. where they are attached by a threaded connection.

Further, either of the terms “or” and “one of ______ and ______,” as used in this disclosure and the appended claims is intended to mean an inclusive “or” rather than an exclusive “or.” That is, unless specified otherwise, or clear from the context, either of the phrases “X employs A or B” and “X employs one of A and B” is intended to mean any of the natural inclusive permutations. That is, either phrase is satisfied by any of the following instances: X employs A; X employs B; or X employs both A and B, regardless whether the phrases “at least one of A or B” or “at least one of A and B” are otherwise utilized in the specification or claims. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

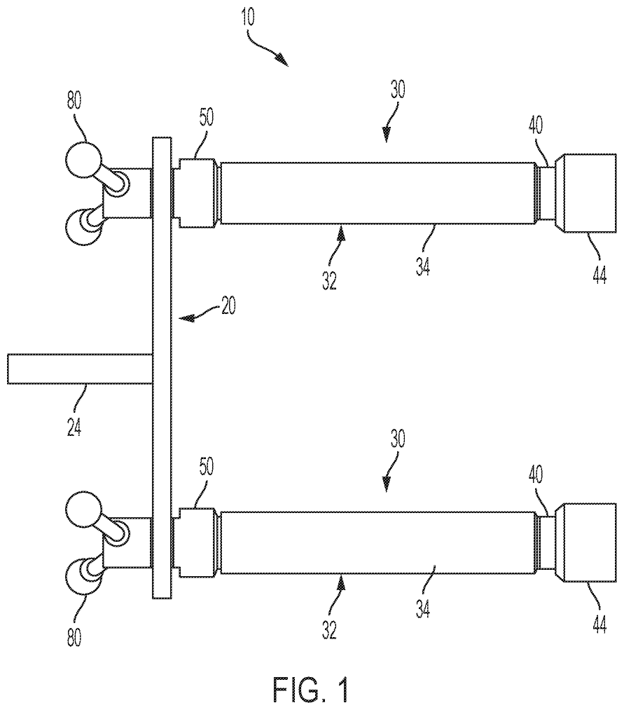

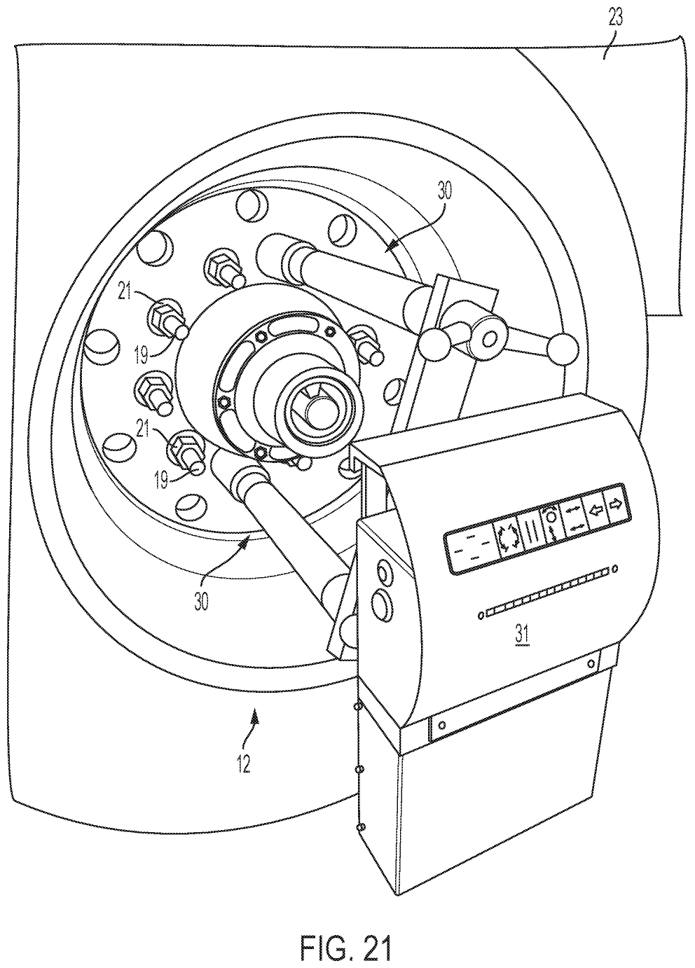

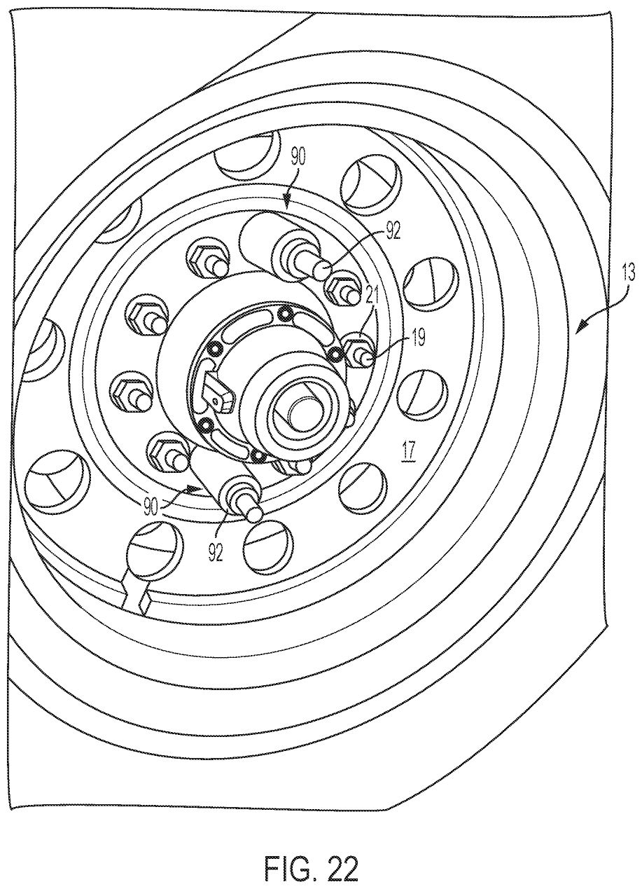

Referring now to FIG. 1, a mounting apparatus 10 is configured, as discussed below, to support a wheel alignment instrument 31 (FIG. 21) of a wheel alignment system 12 (FIG. 21) on the wheel 13 (FIG. 22) of a corresponding vehicle 23 (FIG. 21), e.g. a semi-trailer or larger trailer or tractor. As should be understood, a wheel alignment system may include optical devices 31 (FIG. 21), which may comprise cameras or reflectors that respectively attach to the individual vehicle wheels. A central system processor receives camera images or reflections from the optical devices. Relying on this received information, the processor determines wheel alignment parameters for each wheel with respect to the vehicle's overall suspension system. The arrangement and operation of the optical and processing components of a wheel alignment system should be well understood and are not discussed in further detail herein.

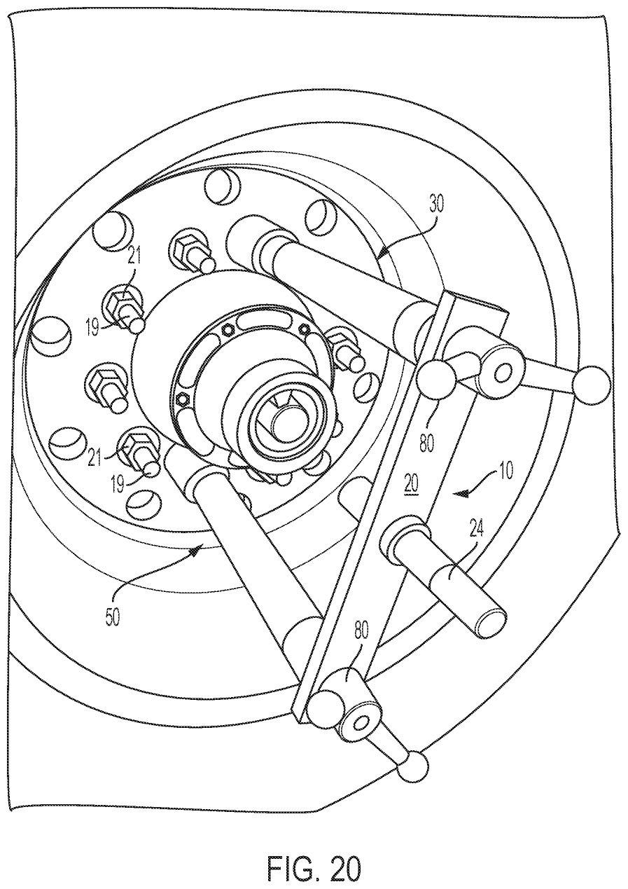

Apparatus 10 may include a pair of mounting tools 30 and a bracket, in this embodiment a mounting bar, 20 extending between the tools 30 that supports and orients mounting tools 30 with respect to each other and extends between the mounting tools at a predetermined position with respect to the wheel. Thus, as in one or more of the illustrated embodiments, the bracket is disposed at a predetermined distance from the wheel (in a direction parallel to the wheel's axis of rotation) as defined by the lengths of the mounting tools. Each mounting tool 30 may be adapted to be secured either directly to a corresponding stud 19 (FIGS. 20-22) of the corresponding wheel 13 (FIG. 20) or, alternately, to a short stud adaptor 90 (FIG. 22) that is secured directly to the corresponding stud 19 (FIGS. 20-22), as discussed in greater detail below.

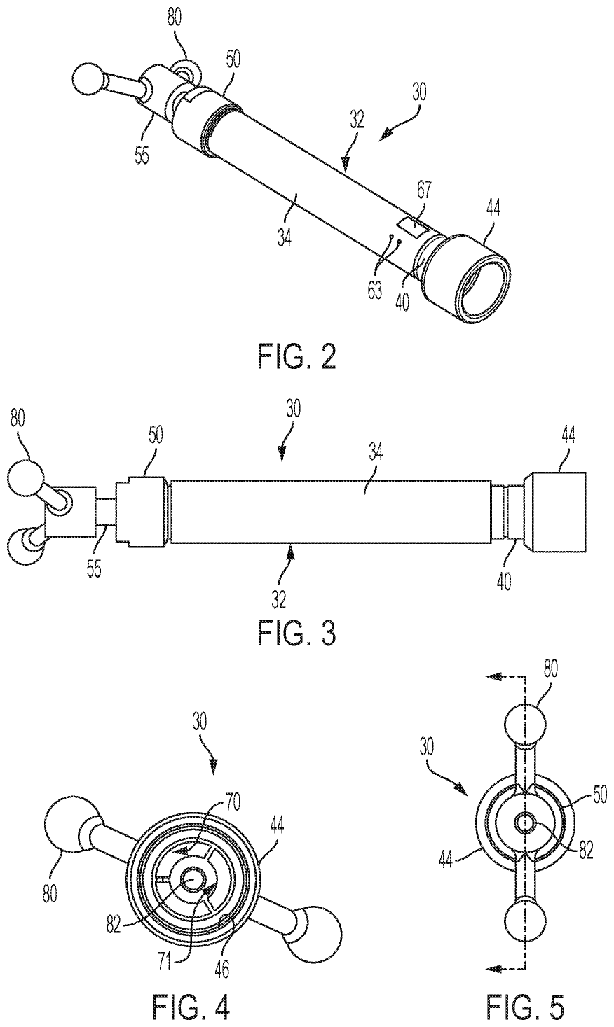

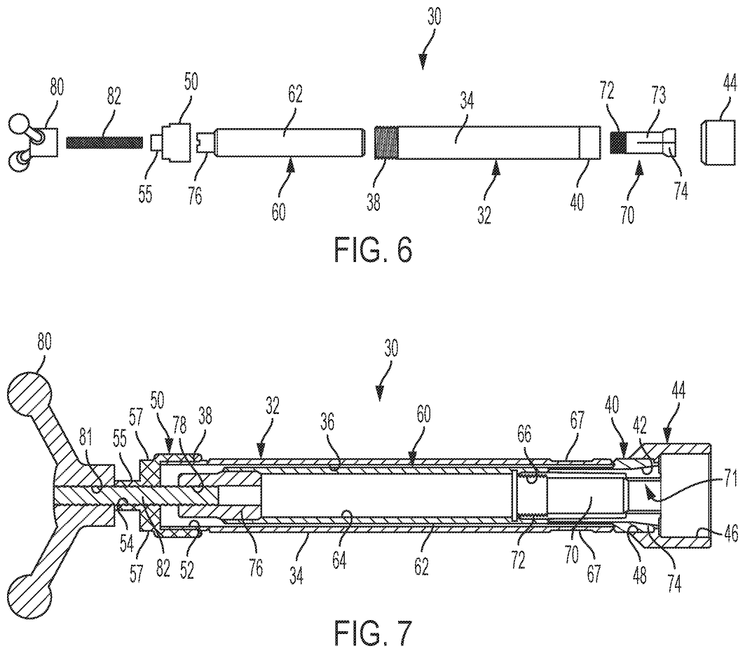

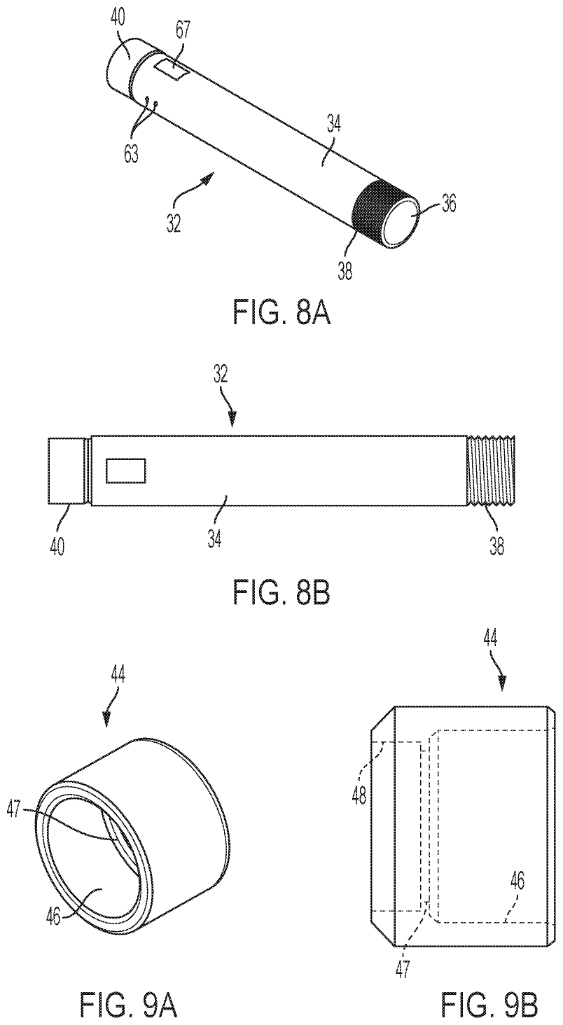

Referring additionally to FIGS. 2 through 7, each mounting tool 30 may include an outer body 32, an inner body 60, a chuck, for example a collet, 70, and a driver, for example a handle, 80. Referring additionally to FIGS. 8A and 8B, outer body 32 may include an elongated outer body portion 34 that defines a through bore 36 along its longitudinal center axis, the through bore being configured to slidably receive inner body 60 therein. Outer body 32 may also include a tapered ring 40 that is received in through bore 36 at a front end of outer body portion 34. Referring to FIGS. 6, 7, 8A, 8B, 10A, and 10B, tapered ring 40 may include a generally cylindrical, hollow body portion 41 that is disposed within through bore 36 and a frustoconical inner surface 42 at a front end of the tapered ring. In this embodiment, tapered ring 40 is non-rotatably fixed to outer body portion 34 of mounting tool outer body 32 by pressing body portion 41 into bore 36 and welding tapered ring 40 to the front end of outer body portion 34. After welding, the weld is machined to thereby define a consistent outer diameter of outer body 32. As shown in FIGS. 1-3, 9A, and 9B, a front end cap 44 of outer body 32 may include a through bore that includes a cylindrical front bore 46 and a cylindrical rear bore 48 that are separated by an annular flange 47 that extends radially-inwardly into the through bore. As illustrated in FIG. 7 (and also with reference to FIGS. 9A and 9B), aluminum front end cap 44 may be non-rotatably fixed to steel outer body portion 34 via tapered ring 40, e.g. by pressing steel tapered ring 40 into rear bore 48 of front end cap 44 until tapered ring 40 abuts annular flange 47. Referring to FIGS. 1-3, 5-7, 12A, and 12B, a steel rear end cap 50 defining a threaded inner bore 52 is operationally non-rotatably secured in this embodiment to the rear end of outer body portion 34 by a correspondingly threaded portion 38 (FIGS. 8A and 8B) defined on the outer surface of outer body portion 34. End cap 50 defines flat surfaces 57 (FIGS. 7 and 12A) that may be gripped by a wrench or pliers to thread end cap 50 tightly onto outer body portion 34. Likewise, a pair of opposing flats 67 (FIGS. 2, 7, 8A, 8B) may be provided on the outer surface of outer body 34 that may be gripped by a tool to hold the outer body against rotation by the end cap as the end cap is rotatably threaded onto the outer body. End cap 50 may also define a rear projection 55 at the end cap's rear that has a flat surface (not shown) of the rear projection that keys to either of two corresponding flat surfaces in the upper and lower surfaces of corresponding apertures 22 defined by mounting bar 20 (FIGS. 16A and 16B) so that the mounting bar 20 is secured to, and supported by, the mounting tools 30, as shown in FIG. 1. The diameter across the end cap at the flat surface of rear projection 55 is slightly smaller than the diameter across the corresponding apertures 22 between their flat surfaces, so that end cap 50 is slidably received into its corresponding mounting tool aperture 22. The two diameters are sufficiently close, however, that each end cap 50, and therefore each outer body portion 34, tapered ring 40, and front end cap 44, i.e. outer body 32, is rotationally fixed (with the exception of a slight rotational tolerance allowed by the sliding fit between the outer body and the mounting bar) with respect to the mounting bar and each other mounting tool outer body (and its non-rotatably attached components) that the mounting bar holds. Each slot 22 is wider (in the dimension normal to the dimension across the slot's flat surfaces) than the width of each rear projection 55 in that dimension to allow sliding movement of the mounting tools within the slots 22, and thereby with respect to the mounting bar, to thereby accommodate varying spacing between the wheel bolts on varying wheels.

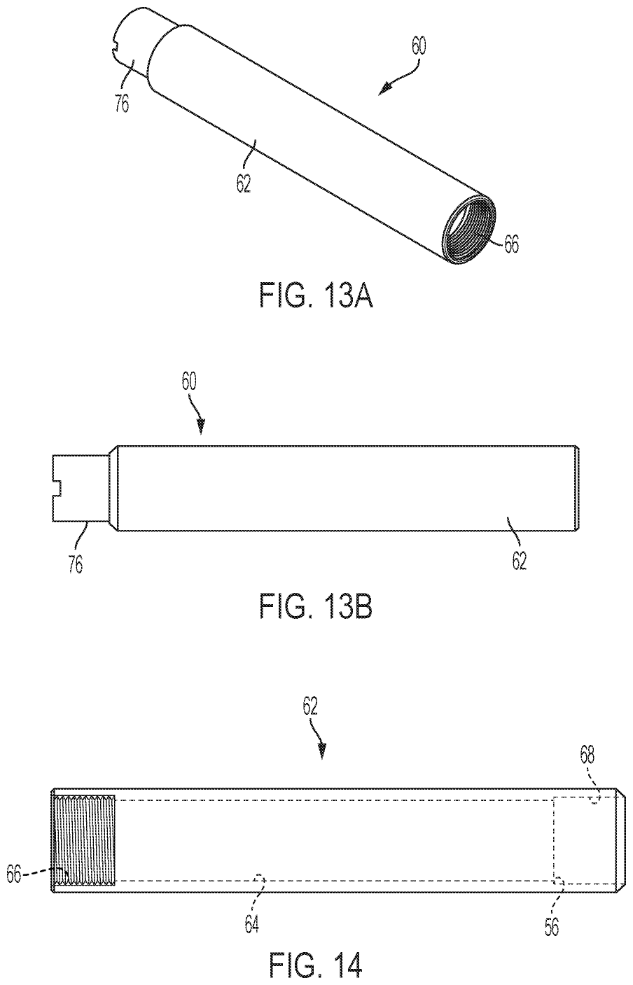

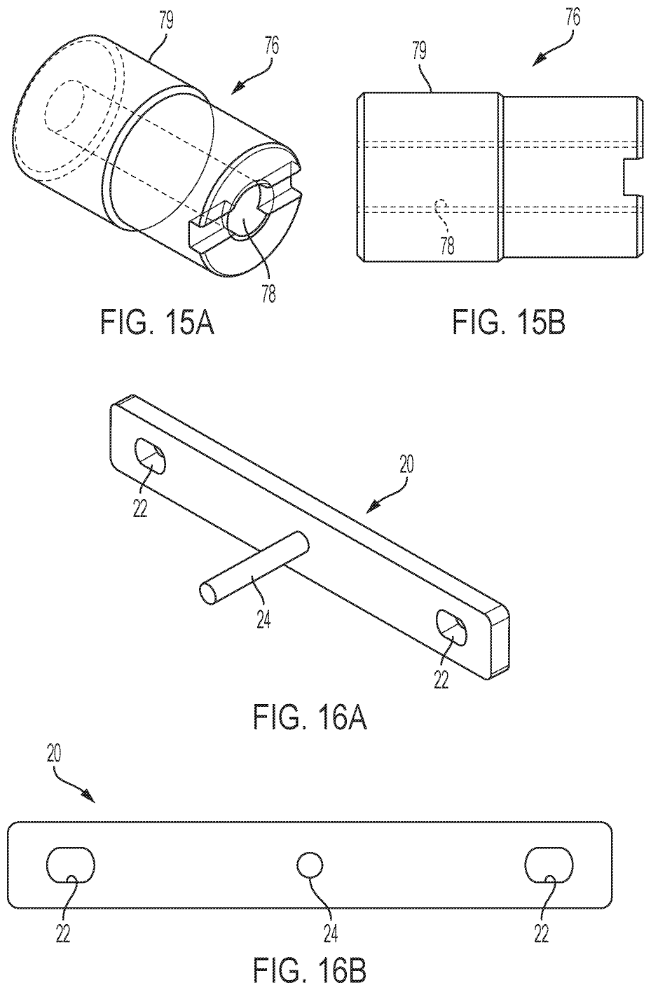

As shown in FIGS. 13A, 13B, and 14, and also with reference to FIGS. 1-3, 6, and 7, inner body 60 of mounting tool 30 may include an elongated inner body portion 62 and a rear plug 76 extending rearwardly from body portion 62 and non-rotatably secured thereto. As best seen in FIG. 14, inner body portion 62 may define a through bore 64 along its longitudinal center axis, the through bore defining a threaded surface 66 at a front end of the through bore and an enlarged smooth bore 68 disposed at a rear end of the through bore, with a rearwardly-facing annular ledge 56 disposed therebetween. Referring additionally to FIGS. 15A and 15B, smooth bore 68 of inner body portion 62 may be configured to receive a cylindrical portion 79 of rear plug 76 therein in a press fit, with the two steel components being welded together as well. Rear plug 76 may define a threaded bore 78 extending therethrough that is configured to threadedly receive a correspondingly threaded stem 82 (FIG. 6) therein, as best seen in FIG. 7. Threaded stem 82 may also extend through a smooth bore 54 (FIG. 12B) of rear end cap 50 of outer body 32 so that stem 82 may rotate about the tool's longitudinal axis within a non-rotating (from the perspective of the stem) rear end cap. A distal end of threaded stem 82 may be threadedly received in a correspondingly threaded bore 81 of aluminum handle 80, as best seen in FIG. 7, so that the stem and handle are non-rotatably fixed to each other. A suitable adhesive, such as sold under the name LOCTITE RED THREADLOCKER by Henkel Corporation of Rocky Hill, Conn., may be disposed between the threads of stem 82 and handle 80, as well as other threaded interfaces as described herein, to increase the hold of the interfaces and prevent de-threading of the corresponding components during use of the embodiments of the device as discussed herein. A pair of set screws 63 (FIGS. 2 and 8A) extend through outer body 34 and into through bore 36 (FIG. 8A) so that the set screws are received into a rear slot 65 in collet 70 (FIGS. 11A and 11B), thereby rotationally fixing collet 70 and inner body 62 with respect to outer body 32. The set screws are slidably received in slot 65, however, thereby allowing the set screws to move with the slot 65 along the slot's length, in turn allowing the axial movement of inner body 62 and collet 70 with respect to outer body 32, as described herein.

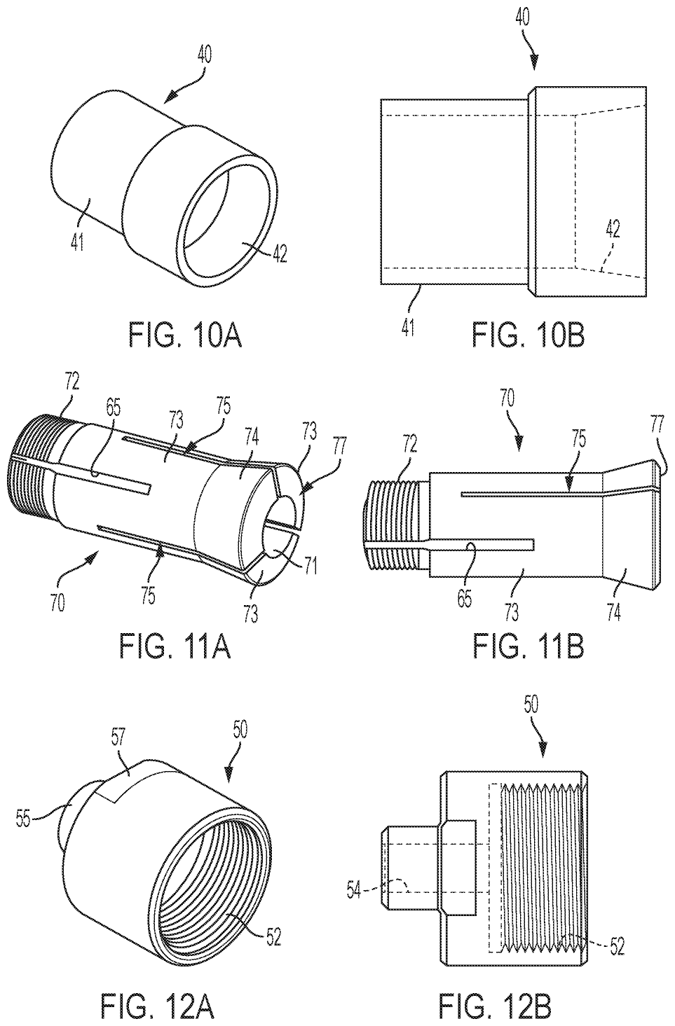

Referring now to FIGS. 6, 7, 11A and 11B, threaded portion 66 of the outer surface of inner body portion 62 is configured to receive a correspondingly threaded outer surface 72 of collet 70. In the illustrated embodiment, collet 70 is a twenty-two millimeter 5C collet made of spring steel that defines a plurality of radial through slots 75 extending axially rearward from a front end 77 of collet 70 toward a threaded rear end 72, thereby defining three collet jaws 73 that, in turn, define an inner bore 71 that is configured to slidably receive a stud 19 of a wheel 13 (FIG. 20) therein, as well as a frustoconical outer surface 74 that is configured to interact with frustoconical inner surface 42 (FIGS. 7, 10A, and 10B) so that collet 70 may be alternatingly non-rotatably affixed to, and released from, a corresponding stud 19.

While a collet 70 is illustrated in the present discussion, it should be understood that this is for purposes of example only. Thus, for example, chuck 70 may be an oblique-jawed type chuck driven by a threaded connection between threads on an inner diameter of a nut defined by the outer body and threads on respective outer surfaces of three jaws, where the jaws are disposed at an oblique angle with respect to the inner and outer bodies' elongated axes. In such an arrangement, the outer body's inner diameter threads engage the outer-surface jaw threads while the jaws are held in position with respect to each other in a carrier defined by the inner body. The inner body is rotationally fixed to the handle but is rotatable with respect to the outer body, such that the handle's rotation about the mounting tool axis by the operator rotates the carrier, and therefore the jaws, about that axis and with respect to the outer body. The threaded connection between the nut and the jaws drives the jaws toward or away from the wheel stud received in the interior bore defined by the jaws' inner surface, depending on the direction of the handle's rotation. Thus, the operator's rotation of the handle in one rotational direction drives the jaws into a gripping engagement of the wheel stud, while the handle's rotation in the opposing rotational direction moves the jaws away from the wheel stud so that the mounting tool may be removed therefrom. Accordingly, it should be understood that various suitable chuck arrangements may be utilized within the scope of the present disclosure.

As indicated in FIG. 7, the forward travel of inner body 60 is limited by a rearward face of tapered ring, or collet nut, 40. At its forwardmost slidable position within outer body 32, the inner body's further forward motion is stopped by engagement of a forward face of inner body portion 62 with the collet nut's rearward face.

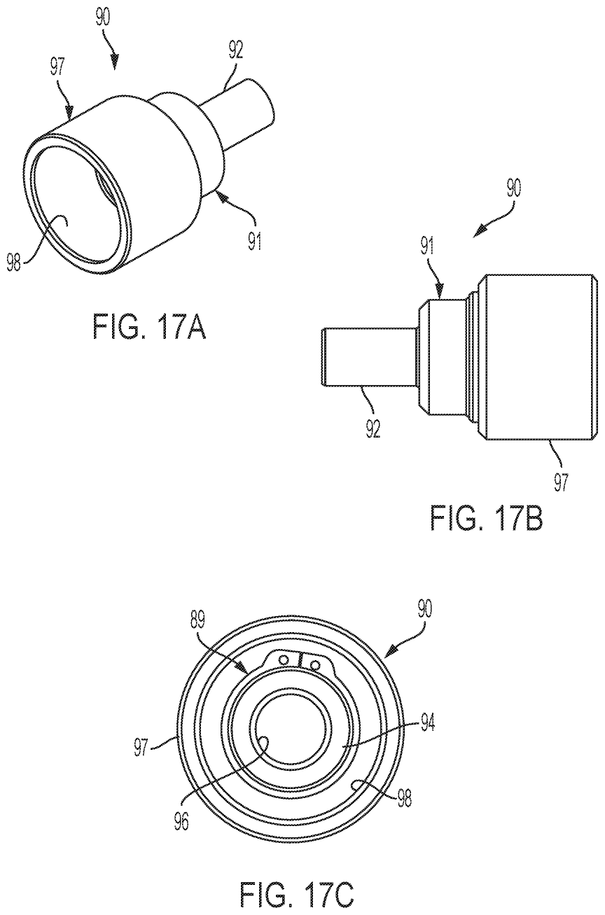

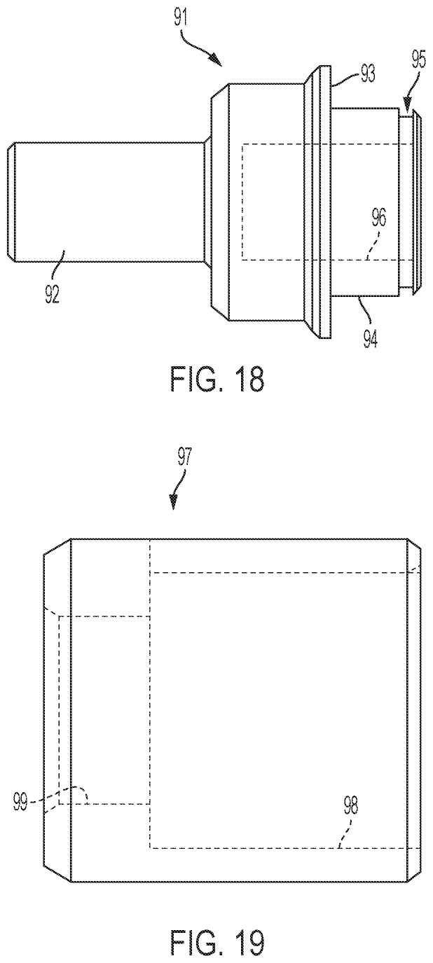

Referring now to FIGS. 17A through 17C, and FIGS. 20 and 22, one or more embodiments of the present disclosure may also provide for a short stud adaptor 90 that facilitates attachment of mounting apparatus 10 (FIG. 1) to a wheel 13 in which the exposed portions of the studs 19 rearward of lug nuts that are threaded onto their studs are not long enough for adequately attaching the previously discussed collet 70 (FIGS. 7, 11A, and 11B). In some embodiments as described herein with regard to FIGS. 1-22, collet 70 may sufficiently grip such exposed stud portion of 0.5 inches, or longer, in length, so that the stud adaptors 90 of the embodiments reflected by FIGS. 17A-17C may be used when the exposed stud portion is less than 0.5 inches in length. As shown, stud adaptor 90 includes a body portion 91 and a front cap 97 that are secured together with a C-clip 89. Referring additionally to FIGS. 18 and 19, body portion 91 may include a cylindrical front portion 94 that slidably receives front cap 97 thereon, and a rear stem 92 that is configured to be slidably received in inner bore 71 of a corresponding collet 70 (FIGS. 7, 11A, and 11B) of mounting tool 30 (FIG. 1). As assembled, front cylindrical portion 94 of body portion 91 may be passed through a rear bore 99 of front cap 97, and C-clip 89 may be received in an annular groove 95 formed in the outer surface of front cylindrical portion 94 so that front cap 97 is axially-fixed between C-clip 89 and an annular flange 93 that extends radially-outwardly from body portion 91. Note, front cap 97 may fit loosely with respect to body portion 91 so that the front cap is rotatable with respect to body portion 91. If front cap 97 is pushed down onto a rim 17 of a wheel 13 about a stud when stud adaptor 90 is being affixed to a stud 19, so that front cap 97 becomes frictionally restrained by the rim, this will allow front cap 97 to cease its rotation with respect to the rim while body portion 91 to continues to rotate as it is threaded onto the stud, thereby lowering the chances of scratching or otherwise damaging the rim. Front cap 97 may also define a cylindrical bore 98 that has a diameter that is greater than the maximum width of the threaded nuts 21 that secure wheel 13 to studs 19 of the corresponding vehicle. Generally cylindrical body portion 91 (including generally cylindrical front portion 91) may define a central threaded bore 96 along its longitudinal center axis and that opens to the forward face of body portion 91. The threads of threaded bore 96 may be sized to mate with the threads of wheel studs 19 so that the operator may hand-thread body portion 91 down onto a stud, as described below. Moreover, it should be understood that stud and stud thread sizes may vary and that adaptors 90 may be sized correspondingly to different stud and thread configurations.

### Operation

Referring additionally to FIGS. 1, 7, 20, and 21, when performing a wheel alignment operation, the user may first place the forward end of each of the two mounting tools over a respective wheel stud 19 so that the wheel stud slides into inner bore 71 of collet 70 of its corresponding one of the two mounting tools 30. When stud 19 is inserted into inner bore 71 of collet 70 to the fullest extent (i.e. when the forwardmost face of front end cap 44 abuts the wheel surface about the stud or when the rearward face of the lug nut on the stud abuts the forward face of annular flange 47 (FIGS. 9A and 9B), whichever occurs first), the corresponding lug nut 21 is at least partially disposed within smooth bore 46 of the mounting tool's front end cap 44. In the illustrated embodiment, bore 46 is circular in cross section. It will be understood in view of the present disclosure, however, that the bore may have a non-circular cross section, for example a cross section generally corresponding in shape to the outer cross-sectional shape of the lug nut the bore receives. In one or more embodiments, the smallest diameter of bore 46 may be greater than the largest outer diameter of the lug nut. In certain embodiments, each front end cap 44 (or end cap 97) is dimensioned so that the corresponding lug nut it receives is fully received within the end cap's bore, so that the end cap locates directly on the wheel rim. In such embodiments, therefore, the overall length of cylindrical tools 30 defines the location and orientation of the alignment instrument 31 (FIG. 21) with respect to the wheel rim. In such embodiments, the two (or more, if present) cylindrical tools 30 are machined after their assemblies so that their lengths (measured between the forwardmost surface of end cap 44 and rearward-facing shoulder surface of rear end cap 50 that engages the forward face of mounting bar 20 when the operator tightens handle 80, eliminating the gap shown for purposes of illustration in FIG. 1 between the forward face of mounting bar 20 and the rearward-facing shoulder surface of rear end cap 50) are within a tolerance of not more than 0.005 inches of each other.

Stud 19 may extend into collet 70 when the collet is in a first position in which its inner bore 71 is at a diameter greater than the stud's diameter, i.e., when the frustoconical inner surface 42 of tapered ring 40 is not engaged with frustoconical outer surface 74 of collect 70 or, if engaged, is in an axial position (with respect to the longitudinal axis of generally cylindrical tool 30) that allows the radially-outward biased jaws 73 of collet 70 to spread sufficiently radially outward so that the diameter of bore 71 is greater than the stud's outer threaded diameter. As described above with regard to one or more embodiments, with both mounting tools 30 engaged to a stud, the keyed engagements between the respective flats on rear projections 55 (FIGS. 12A and 12B) and the flats defined by apertures 22 in mounting bar 20 (FIGS. 16A and 16B) rotationally fix the tools 30 with respect to each other, the mounting bar, and, therefore, with respect to the vehicle wheel about the stud axis, such that the tools do not rotate during the mounting operation. With stud 19 inserted in collet 70 to the fullest extent and the lug nut fully received within the front end cap (see above), the user may hold the mounting bar or the outer body 32 of the mounting tool 30 being attached to a stud to thereby apply forward pressure to the mounting tool where the outer body's forward face abuts against the rim, while simultaneously rotating that tool's handle 80 in a clockwise direction (when viewing mounting tool 30 from the rear). As the mounting bar holds the outer body against rotation relative to the wheel rim, scratches to the wheel rim may be avoided during the process of mounting the tool directly to the wheel stud. Due to the threaded engagement between the handle and stem 82 (FIG. 7) in such embodiments, rotation of handle 80 in such clockwise direction causes threaded stem 82 to be inserted deeper into threaded bore 78 of rear plug 76 of the mounting tool's inner body 60. In so doing, inner body 60 is moved axially-rearwardly within outer body 32, which is axially stationary with respect to the wheel rim, hub, and studs, so that frustoconical outer surface 74 of collet 70 (moving rearwardly with respect to outer body 32, the rim, hub, and stud) engages frustoconial inner surface 42 of axially stationary tapered ring 40, thereby causing jaws 73 of collet 70 to be urged radially-inwardly until they grippingly engage stud 19 with sufficient force that the mounting tools hold both the mounting bar and the wheel alignment optical device, without detaching from the studs, when the wheel alignment optical device is attached to the mounting bar. As the collet tightens, the collet slips on the stud threads until the increasing friction stops such movement, at which point the tool 30 draws up to the wheel rim slightly, causing the system to tighten. Thus, tightening of handle 80 causes collet 70 to be drawn tight onto a stud, while locating the width of the tool on mounting bar 20 by drawing the mounting bar up against the rear-facing shoulder of rear end cap 50 (FIG. 1). The operator may repeat this process on a stud 19 of the wheel 13 that is directly opposite the previously engaged stud 19, as shown in FIG. 19. Next, as shown in FIG. 20, wheel alignment instrument 31 of the wheel alignment system may be slidably disposed on a mount, in the illustrated embodiment a stud, 24 of mounting bar 20, as shown in FIG. 20. For this purpose, the end of shaft 24 of mounting tool 20 (FIG. 1) may be threaded to threadedly receive a locking nut to hold the alignment instrument 31 (FIG. 21) in place on the mounting bar. The operator, having selectively mounted the alignment instrument on the stud, then performs the wheel alignment operation.

Referring to FIGS. 1, 12A, and 12B, in certain embodiments and as noted above, the system 10 includes two mounting tools 30 that attach to two respective studs 19 (FIG. 20) that directly oppose each other across the wheel hub (i.e. a line normal to the axis of rotation of the wheel and hub in the vehicle's operation and passing through both opposing studs also passes through the axis of rotation). Tool mounting apertures 22 are disposed in the main portion of mounting bar 20 a distance apart from each other (measured as the distance between the apertures' centers) so that the apertures' openings encompass the end points of the distance between each such pair of opposing studs (also measured as the distance between the studs' centers), thereby allowing the alignment of the respective collet internal bores 71 (FIG. 11A) of the two mounting tools simultaneously over the two opposing studs and the simultaneous attachment of the two mounting tools to those studs while the mounting tools are secured by the mounting bar. In such embodiment, as illustrated in the Figures herein, the generally linear main portion of mounting bar 20 extends through (and normal to) the wheel's/hub's rotational axis, and mounting stud 24 extends from the mounting bar main portion aligned with that rotational axis. Thus, the attachment of wheel alignment optical device 31 (FIG. 21) onto hub 24 disposes the optical device in a predetermined position and orientation with respect to the wheel/hub rotational axis and with respect to the wheel and hub. It should be understood, however, that such arrangement is for purposes of example only, and that the present disclosure encompasses tool/mounting bar/mounting hub arrangements that mount the optical device in different predetermined positions and orientations with respect to the wheel and hub. Still further, it is also possible that the vehicle's hub assembly defines studs that are disposed in a pattern around the rotational axis such that no two studs directly oppose each other across the hub's rotational axis. For such wheels/hubs, mounting bar 20 may be arranged to extend over three (or more) studs, with three (or more) apertures 22 disposed in the mounting bar so that respective mounting tools 30 secured in those apertures may be simultaneously attached to three (or more) studs, and with mounting stud 24 disposed on the mounting bar between those apertures so that, when those three (or more) mounting tools are attached to their studs as described herein, mounting stud 24 is again aligned with the hub's rotational axis or in any other desired location.

Referring now to FIG. 21, in those instances in which the length of exposed stud 19 may be too short to adequately attach mounting apparatus 10 by way of collet 70, stud adaptors 90 may first be attached to the studs 19. To mount stud adaptor 90 on a stud 19 in such embodiments, body portion 91 of stud adaptor 90 is rotated so that stud 19 is threadably received in and tightened threaded bore 96 thereof. Body portion 91 is independently rotatable of front cap 97 so that front cap 97 may remain non-rotatable with respect to a rim 17 of the wheel 13. As such, scratches to the rim 17 may be avoided while mounting stud adaptor 90 to the corresponding stud 19. Once both stud adaptors 90 are mounted to opposing studs 19, each mounting tool 30 may be secured to a rear stem 92 of a corresponding stud adaptor 90 in the manner discussed above for securing mounting tools 30 directly to the wheel's studs 19.

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

What is claimed:

1. A mounting apparatus for attaching a wheel alignment instrument of a wheel alignment system to at least one stud of a wheel of a vehicle, comprising:
a plurality of mounting tools, each mounting tool of the plurality of mounting tools comprising
a first body, and
a second body disposed with respect to the first body so that a relative movement between the first body and the second body causes an engagement between the first body and the second body that drives the first body into gripping engagement with a wheel stud received by the second body; and
a bracket attached to each mounting tool of the plurality of mounting tools, the bracket extending between the mounting tools of the plurality of mounting tools at a predetermined position with respect to the wheel when the mounting tools are mounted on the wheel and having a mount configured to receive the wheel alignment instrument so that the wheel alignment instrument is disposed at a predetermined orientation with respect to the wheel.

2. The mounting apparatus as in claim 1, wherein the second body of each mounting tool of the plurality of mounting tools comprises a chuck.

3. The mounting apparatus as in claim 2, wherein the chuck of each mounting tool of the plurality of mounting tools is a collet.

4. The mounting apparatus as in claim 1, wherein each mounting tool of the plurality of mounting tools comprises a hand-actuatable driver operatively connected to the second body so that actuation of the hand-actuatable driver moves the second body relative to the first body to cause the engagement between the first body and the second body.

5. The mounting apparatus of claim 3, wherein
each mounting tool of the plurality of mounting tools comprises a hand-actuatable driver operatively connected to the second body so that actuation of the hand-actuatable driver moves the second body relative to the first body to cause the engagement between the first body and the second body,
the first body and the second body, of each mounting tool of the plurality of mounting tools, are rotationally fixed with respect to each other, and
the driver, of each mounting tool of the plurality of mounting tools, is threadedly connected to the second body and is fixed with respect to the first body in a first direction parallel to an axis of elongation of the first body so that rotation of the driver in a first rotational direction moves the collet with respect to the first body in a second direction parallel to the axis of elongation opposite to the first direction parallel to the axis of elongation and draws the collet into gripping engagement with the wheel stud.

6. The mounting apparatus as in claim 2, wherein the chuck, of each mounting tool of the plurality of mounting tools, is disposed at an end of the second body, and an end cap is attached at an end of the first body proximate the chuck, and wherein the end cap defines an internal bore that extends to an open end of the end cap disposed beyond the chuck.

7. A mounting apparatus for attaching a wheel alignment instrument of a wheel alignment system to at least one stud of a wheel of a vehicle, comprising:
a first mounting tool and a second mounting tool, each of the first mounting tool and the second mounting tool comprising
an elongated body having a front end, a rear end and a through bore extending along a longitudinal center axis of the elongated body, and
a collet defining an internal bore configured to receive a wheel stud therein, the collet being slidably received in the through bore of the elongated body so that an outer surface of the collet abuts an inner surface of the front end of the elongated body,
wherein the collet is axially slidable with respect to the elongated body between a first position in which the collet is rotatable with respect to the wheel stud and a second position in which the inner surface of the front end of the elongated body engages the outer surface of the collet to drive the collet to grippingly engage the wheel stud; and
a bracket having a first end that is secured to the first mounting tool, a second end that is secured to the second mounting tool, and a mounting stud configured for selectively disposing the wheel alignment instrument on the bracket.

8. The mounting apparatus of claim 7, wherein the outer surface of the collet of each of the first mounting tool and the second mounting tool defines a frustoconical surface and the inner surface of the front end of the elongated body of each of the first mounting tool and the second mounting tool defines a frustoconical surface.

9. The mounting apparatus of claim 8, wherein each of the first mounting tool and the second mounting tool comprises an inner body comprising the collet and an inner body portion having a rear end and a front end attached to the collet, wherein the collet further comprises a body portion with a threaded outer surface, the inner body portion defines a corresponding threaded inner surface, and the collet is non-rotatably fixed to the inner body portion by threaded engagement between the threaded inner surface and the threaded outer surface.

10. The mounting apparatus of claim 9, wherein each collet of the first mounting tool and the second mounting tool further comprises a plurality of radially flexible jaws extending from the body portion.

11. The mounting apparatus of claim 8, wherein each of the first mounting tool and the second mounting tool comprises
an inner body comprising the collet and an inner body portion having a rear end and a front end attached to the collet, and
a handle extending axially-outwardly from the rear end of the elongated body, the handle comprising a threaded stem that is rotatably received in a threaded bore disposed at the rear end of the inner body portion so that rotation of the handle in a first direction with respect to the elongated body moves the inner body axially-rearwardly with respect to the elongated body and moves the collet from the first position to the second position.

12. The mounting apparatus of claim 11, wherein rotation of the handle of each of the first mounting tool and the second mounting tool in a second direction that is opposite to the first direction moves the collet from the second position to the first position.

13. The mounting apparatus of claim 7, wherein the elongated body of each of the first mounting tool and the second mounting tool has a front end cap defining the front end of the elongated body, the front end cap defining a cylindrical bore that receives a lug nut of the wheel stud therein.

14. A wheel alignment system for a wheel of a vehicle, the wheel having a plurality of studs, comprising:
a first mounting tool and a second mounting tool, each of the first mounting tool and the second mounting tool comprising:
an outer body having an elongated outer body portion having a front end, a rear end and a through bore extending along a longitudinal center axis of the outer body portion; and
an inner body having an elongated inner body portion having a front end and a rear end, and a collet secured to the front end of the inner body portion, the collet defining an internal bore configured to receive a wheel stud therein, the inner body portion being slidably received in the through bore of the outer body portion so that an outer surface of the collet abuts an inner surface of the front end of the outer body portion,
wherein the inner body is axially slidable with respect to the outer body between a first position in which the collet is rotatable with respect to the wheel stud and a second position in which the inner surface of the front end of the outer body portion engages the outer surface of the collet to drive the collet to grippingly engage the wheel stud; and
a bracket defining a first mounting aperture, a second mounting aperture, and a mounting stud extending outwardly therefrom, wherein the first mounting tool extends through the first mounting aperture and the second mounting tool extends through the second mounting aperture; and
a wheel alignment instrument that is selectively disposed on the mounting stud of the bracket.

15. The wheel alignment system of claim 14, wherein the outer surface of each collet defines a frustoconical surface and the inner surface of the front end of each outer body portion defines a frustoconical surface.

16. The wheel alignment system of claim 15, wherein each collet further comprises a body portion with a threaded outer surface, each inner body defines a threaded inner surface, and each collet is non-rotatably fixed to a said inner body by a said threaded inner surface and the threaded outer surface.

17. The wheel alignment system of claim 15, wherein each of the first mounting tool and the second mounting tool comprises a handle extending axially-outwardly from the rear end of the outer body, the handle comprising a threaded stem that is rotatably received in a threaded bore disposed at the rear end of the inner body so that rotation of the handle in a first direction with respect to the outer body moves the inner body axially-rearwardly with respect to the outer body and moves the collet from the first position to the second position.

18. The wheel alignment system of claim 17, wherein each of the first mounting tool and the second mounting tool is configured so that rotation of the handle in a second direction that is opposite to the first direction moves the collet from the second position to the first position.

19. The wheel alignment system of claim 14, wherein each outer body of each of the first mounting tool and the second mounting tool comprises a front end cap extending axially-outwardly from the front end of the outer body, the front end cap defining a cylindrical bore that receives a lug nut of said wheel stud therein.

20. A mounting apparatus for attaching a wheel alignment instrument of a wheel alignment system to a wheel, comprising:
a plurality of mounting tools, each mounting tool comprising
a collar that defines a first internal bore and a first engagement surface, and
a collet disposed slidably within the first internal bore and having a plurality of jaws that define an exterior second engagement surface and a second internal bore,
wherein the collet is slidable within the first internal bore between a first position with respect to the collar in which the first engagement surface and the second engagement surface are disposed with respect to each other so that a diameter of the second internal bore is greater than an outer surface diameter of a wheel stud of the wheel and a second position with respect to the collar in which the first engagement surface and the second engagement surface engage each other and force the jaws radially inward so that the jaws grippingly engage the wheel stud when the wheel stud is disposed within the second internal bore; and
a bracket attached to each mounting tool of the plurality of mounting tools, the mounting bracket extending between the mounting tools of the plurality of mounting tools at a predetermined position with respect to the wheel when the mounting tools of the plurality of mounting tools are mounted on the wheel and having a mount thereon configured to receive the wheel alignment instrument so that the wheel alignment instrument is disposed at a predetermined orientation with respect to the wheel.

21. A method of attaching a wheel alignment instrument of a wheel alignment system to at least one stud of a wheel of a vehicle, comprising the steps of:
providing a plurality of mounting tools, each mounting tool of the plurality of mounting tools comprising
a first body, and
a second body disposed with respect to the first body so that a relative movement between the first body and the second body causes an engagement between the first body and the second body that drives the first body into gripping engagement with a wheel stud received by the second body;
providing a bracket attached to each mounting tool of the plurality of mounting tools, the bracket extending between the mounting tools of the plurality of mounting tools at a predetermined position with respect to the wheel when the mounting tools of the plurality of mounting tools are mounted on the wheel and having a mount configured to receive the wheel alignment instrument so that the wheel alignment instrument is disposed at a predetermined orientation with respect to the wheel; and
mounting the wheel alignment instrument on the mount.
